(19) United States
(12) Patent Application Publication
(10) Pub. No.: US 2012/0292414 A1
(43) Pub. Date: Nov. 22, 2012

(54) METHOD AND APPARATUS FOR COLLECTION, PROCESSING, AND REMOVAL OF GLASS

(76) Inventor: Maurice Collins, Philadelphia, PA (US)

(21) Appl. No.: 13/451,371

(22) Filed: Apr. 19, 2012

Related U.S. Application Data
(60) Provisional application No. 61/476,824, filed on Apr. 19, 2011.

(51) Int. Cl. B02C 23/02; B60P 1/60; B02C 23/20

(52) U.S. Cl. 241/18; 241/60; 406/39

(57) ABSTRACT

A sealed collection container may be used for collecting glass, imploding glass into sharp free particles, and storing the imploded sharp free glass particles. A vacuum collection truck may be used for emptying the sealed collection container. The vacuum collection truck may include a tube or suction hose that engages the sealed collection container for emptying the sealed collection container via vacuum collection of the imploded sharp free glass particles.

### CROSS REFERENCE TO RELATED APPLICATION

This application claims the benefit of U.S. Provisional Application No. 61/476,824 filed Apr. 19, 2011, the contents of which is hereby incorporated by reference herein.

### FIELD OF INVENTION

The present invention is generally related to an environmental solution. More particularly, the present invention relates to a method and apparatus for collecting, processing, and removing glass.

### BACKGROUND

Glass products make up a large part of household and industrial waste due to the many common uses for glass. Common glass products include, for example, bottles, broken glassware, and light bulbs. The size, weight, and density of glass contribute to the amount of waste caused by glass products.

Glass recycling is the process of turning waste glass products into usable products. Glass recycling uses less energy than manufacturing new glass and prevents already used glass products from being discarded. Typically, glass products are collected in large containers for eventual recycling. It is advantageous to crush the glass products into smaller pieces to reduce storage size. Further, crushed glass is ready to be remelted and turned into other glass products. Crushed glass is often referred to as glass cullet.

Storage and collection of glass is a highly labor-intensive and expensive process. Saving labor, reducing collection costs, freeing up additional space, and increasing recycling are all advantageous for businesses. Current solutions do not meet these goals due to expensive lift fees, an excessive amount of space used for holding glass, and increased labor requirements. Further, the high energy demands and noise levels of the current collection systems are increasing the carbon footprint. Therefore, efficient collection, processing, and removal of glass are particularly important for both economic and environmental purposes.

### SUMMARY

A method and apparatus for collection, processing, and removal of glass is described. A sealed collection container may be used for collecting glass, imploding glass into sharp free particles, and storing the imploded sharp free glass particles. A vacuum collection truck may be used for emptying the sealed collection container. The vacuum collection truck may include a tube or suction hose that engages the sealed collection container for emptying the sealed collection container via vacuum collection of the imploded sharp free glass particles.

### BRIEF DESCRIPTION OF THE DRAWINGS

A more detailed understanding may be had from the following description, given by way of example in conjunction with the accompanying drawings wherein:

FIG. 1 shows an example of a sealed collection container;

FIG. 2 shows an example of a vacuum collection truck; and

FIG. 3 shows an example process for collecting, imploding, and removing glass from a sealed collection container via a vacuum collection truck.

### DETAILED DESCRIPTION

The present invention will now be described with reference to the drawings. The environmental solution described herein uses glass implosion technology to efficiently compact various types of glass into sharp free particles. The glass implosion technology offers benefits over traditional slow speed glass crushers. Glass implosion technology is reliable and consumes less power than traditional glass crushers. The environmental solution may also include a sealed collection container for efficiently storing the imploded glass and a vacuum truck collection system for efficiently collecting the imploded glass.

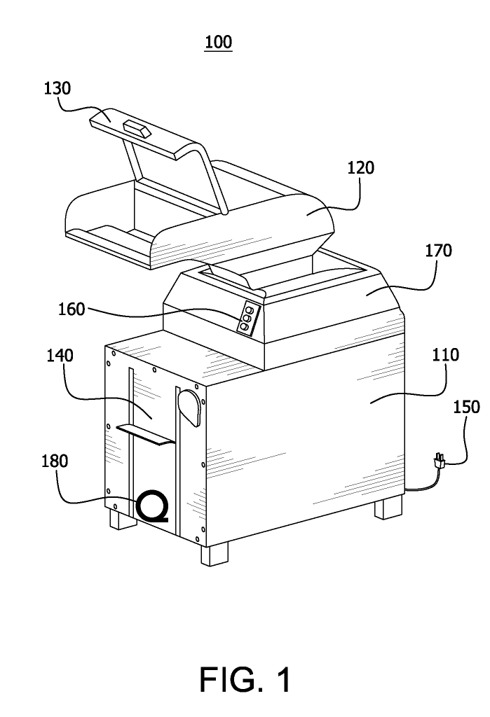

FIG. 1 shows an example of a sealed collection container 100. The sealed collection container 100 may include a tank 110, a feeder 120, a feeder door 130, a tank door 140, a power source 150, a control mechanism 160, an intermediate section 170, and a connection mechanism 180. The sealed collection container 100 may be used for processing and storage of glass. The sealed collection container 100 may include a GP3 glass imploder (not shown). The sealed collection container 100 may provide, for example, a six-to-one compaction ratio of glass. The sealed collection container 100 may be provided in a variety of sizes and the tank 110 may, for example, be capable of holding between 1.5 tons and 3.5 tons of imploded glass. The sealed collection container 100 may include one or more side sections to expand the tank 110 to further increase the capacity, depending on the desired capacity. The inner walls of the sealed collection container 100 may be lined with a hard plate. The sealed collection container 100 may be any container capable of holding any particles and need not be sealed at any or all times.

The sealed collection container 100 may include a tank 110 of any size as described above. Alternatively or additionally, the sealed collection container 100 may be capable of having additional side sections attached. As shown in FIG. 1, the tank 110 as shown does not include any additional side sections. The tank 110 may have, for example, a 7 yard capacity for glass. The total capacity of the tank may be, for example, 1.5 tons, as described above. In another example, the tank 110 may include one additional side section. The tank 110 with one additional side section may include the same features as the tank 110 described above. The additional side section may be attached to one side of the tank 110. The tank 110 with one additional side section may have, for example, a 12 yard capacity for glass. The total capacity of the tank 110 may be, for example, 2.5 tons. In another example, the tank 110 may include two additional side sections. The tank 110 with two additional side sections may include the same features as the tank 110 described above. Each additional side section may be attached to one or more sides of the tank 110. The tank 110 with two additional side sections may have, for example, a 19 yard glass capacity. The total capacity of the tank 110 may be, for example, 3.5 tons. Each additional section in each of the examples described above may be added separately and at any time and may not need to be installed at the time of installation or manufacture.

The tank 110 and side sections described above are for exemplary purposes only. Any number of options and sizes may be available. For example, the capacity of the tank 110 may be one or more of 1 ton, 2.25 tons, 3.375 tons, and/or 4.5 tons. One skilled in the art will recognize that any number of side sections and/or tank 110 sizes will fall within the scope of this example.

The upper portion of the sealed collection container 100 may include the feeder 120. The feeder 120 may be a multiple bottle feed hopper capable of glass intake. The feeder 120 may include a feeder door 130. The feeder door 130 may be, for example, a lid for a feed hopper. The feeder door 130 may be opened or closed. For example, the feeder door 130 may be closed when not in use or may be closed after glass is placed in the feeder 120. Glass may be poured into the sealed collection container 100 via the feeder 120. The feeder 120 may feed the glass to another portion of the sealed collection container 100 such as, for example, the imploder or the tank 110. As described above, the sealed collection container 100 may include glass implosion technology that may compact various types of glass into sharp free particles. The sharp free particles may be stored in a lower portion of the sealed collection container 100, such as the tank 110.

The intermediate section 170 may be in between the feeder 120 and the tank 110. The intermediate section 170 may, for example, include the glass implosion technology that is used to create sharp free particles from the glass that is placed in the feeder 120. The sharp free glass particles may be of a relatively small size. The sharp free glass particles may be handled by humans without any risk of injury or cuts. The sealed collection container 100 may also include a control mechanism 160 that may optionally be located on the intermediate section 170. The control mechanism 160 may be capable of performing any control function for the sealed collection container 100. For example, the control mechanism 160 may power the sealed collection container 100 on or off, may control speeds or settings, or may provide indications to a user.

The lower section of the sealed collection container 100 may safely store the processed glass cullet (sharp free particles) in the tank 110. The tank 110 may include a tank door 140 to allow access to the interior of the tank 110. For example, the tank door 140 may allow a user to access or remove the sharp free particles from the tank 110. The sealed collection container 100 may also include a connection mechanism 180. The connection mechanism 180 may be used to access the sharp free particles stored in the sealed collection container 100. For example, the connection mechanism 180 may be used for emptying the sharp free particles from the sealed collection container 100, as will be described in further detail below. The connection mechanism 180 may optionally be located at the tank 110, although the connection mechanism may be anywhere on the sealed collection container 100.

The sealed collection container 100 may include global positioning system (GPS) technology (not shown) to provide timely information regarding the location and fill level of the sealed collection container 100. As an example, the sealed collection container 100 may operate at 220 v, single phase 50/60 Hz, 13 amp 1.5 kw. The sealed collection container 100 may include noise reduction technology that reduces the noise related to glass implosion. The sealed collection container 100 may be constructed with any material capable of holding sharp free particles. For example, the sealed collection container 100 may comprise sturdy powder-coated materials manufactured to BS EN ISO 9002.

The sealed collection container 100 may include one or more safety controls. For example, an emergency stop switch may be used to isolate the incoming power supply and provide a quick or instantaneous stop feature. As another example, a bin door limit switch may be installed to ensure that the imploder may not operate while a door or compartment is open. The bin door limit switch may include a “fail safe” feature such that the imploder may not be operated if the bin door limit switch is not functioning properly. As another example, a feeder door 130 (feed hopper lid) switch and magnet may be included to prevent objects from being placed into the feeder 120 (feed hopper) while the sealed collection container 100 is not running. For example, a magnet may hold the feeder door 130 in a closed position while the sealed collection container 100 is not running. As another example, a mechanical overload feature may ensure that a main driver motor of the imploder is not overloaded at any time. Some or all of the above-described safety controls may be located on or controlled by the control mechanism 160.

The sealed collection container 100 (and/or the glass imploder used by the sealed collection container 100) may also include other optional control features. For example, a light may indicate when the power source 150 is active and the glass imploder is ready to be used. As another example, a level sensor may be provided to indicate the level at which the sealed collection container 100 or tank 110 is filled. Level sensing sonar may be installed within the sealed collection container 100, tank 110, or imploder and may provide a percentage indicating the fill level of the sealed collection container 100 or tank 110. Optionally, a message may be sent to a collection company at a desired fill level. Optionally, the sealed collection container 100 may be prevented from running if the fill level is 100%. Some or all of the above-described control features may be located on or controlled by the control mechanism 160.

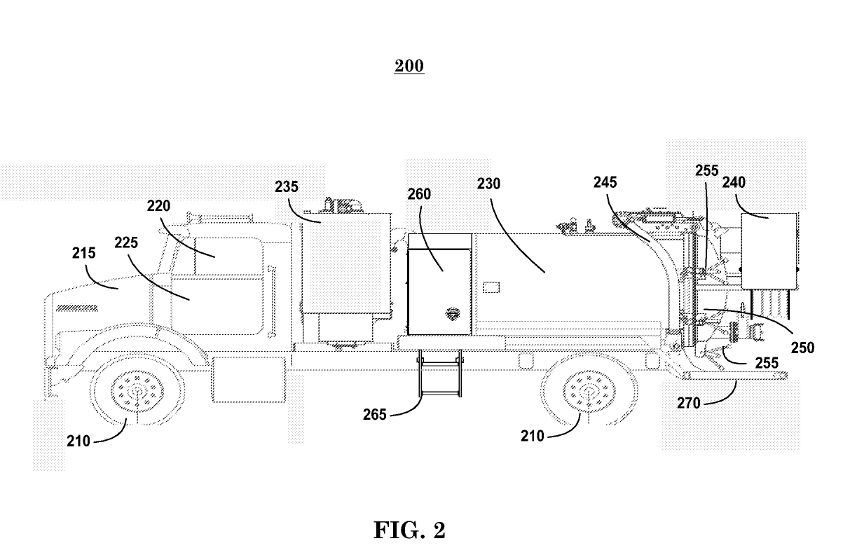

FIG. 2 shows an example of a vacuum collection truck 200. The vacuum collection truck 200 may be used to remove or empty sharp free particles from the sealed collection container 100. The vacuum collection truck 200 may be an automobile or vehicle that is capable of transporting sharp free glass. The vacuum collection truck 200 may include features of a vehicle, for example, the vacuum collection truck 200 may include tires 210, a front mechanical portion 215 (that may include a transmission), at least one glass portion 220, and at least one door 225. The vacuum collection truck 200 may also include a tank 230, a vacuum pump 235, a vacuum system 240, a suction hose 245, a rear door 250, a locking system 255, a tank door 260, an access apparatus 265, and at least one hydraulic lift 270. More than one of the above-mentioned features may be included in the vacuum collection truck 200.

The tank 230 may be used to store and/or collect sharp free particles. The sharp free particles may be, for example, removed from the sealed collection container 100. The tank 230 may be of any size that is capable of holding any amount of sharp free particles from any number of sealed collection containers 100. For example, the tank 230 may be a 2,000 gallon tank. The tank 230 may have, for example, a 20,000 pound processed glass capacity. The tank 230 may be formed from any solid material. The tank 230 may be any structure capable of glass storage. For example, the tank 230 may be constructed from mild steel and may include reinforcement ribs fitted for structural support. The tank 230 may include a stainless steel wear plate (not shown) fitted on the inside of the tank 230. The stainless steel wear plate may be on any portion of the inside of the tank 230, for example, on a bottom portion of the tank. The stainless steel wear plate may be, for example, on the bottom half of the tank. The vacuum collection truck 200 with the tank 230 may allow for at least three times the capacity of an ordinary collection truck based on the features described above.

The tank 230 may include a primary shut-off system (not shown). The primary shut-off system may include a stainless steel float ball and buna seat and may be located in, for example, the front top center of the tank 230. A liquid level indicator with a stainless steel one-piece shaft and a stainless steel float ball may be provided in the rear head of the tank 230 with an exterior indicator arrow. The liquid level assembly may include a quad seal bushing with a viton o-ring seal and may be replaceable from the outside of the tank 230. Baffle assemblies may be bolted in place to protect against anti-surge of liquid or slurry during transportation. Large top and/or bottom clearances may be provided for easy flow of the product during unloading. An automatic pressure relief valve may be provided on the tank 230 and may be set to the design pressure of the tank 230.

The tank 230 may be constructed of, for example, carbon steel and may be rated, for example, for continuous maximum vacuum operation and 15 PSI working pressure. Horizontal and longitudinal seams may be submerge arc welded. The tank 230 may be built as a non-spec/non-code tank. The rear head of the tank 230 may be ASME flanged and dished type, hinged at the top with one or more given diameter bronze oil-lite bushings, and/or sealed with a neoprene rubber gasket. The full opening rear head may open hydraulically if the tank 230 is raised. Forged “T” bolt wing nut-type fasteners with thread protectors and grease zerk fittings may be used to secure the rear head. One or more variable-sized rear nozzles may be flanged with bolted piston type valves and dust caps. One or more of the nozzles may include an internal standpipe with an exit elbow that may terminate at the top of the tank. A 30/30 liquid filled vacuum/pressure gauge may be located at the upper rear portion of the tank 230 and may, for example, register the “inches of mercury” (Hg) or “pounds per square inch” (PSI) inside the debris tank 230.

A three-stage double acting hydraulic cylinder may be mounted to the front head to lift the tank 230 and may provide an automatic lock when the tank 230 is in the lowered transport position. Trunions installed on each side of the lift cylinder may include grease zerks for periodic lubrication. The tank 230 may hinge at the rear on two solid bar pins, with grease zerks, which may be adapted or engaged with the main body main support rails. The hydraulic lift cylinder may use hydraulic power to raise or lower the tank 230. Some or all of the features described above may be included in the hydraulic lift 270. The tank door 260 may be used to access the tank 230 in any manner. For example, the tank door 260 may be used to access, empty, or repair the tank 230. The access apparatus 265 may be used to access the tank 230 or the tank door 260. The access apparatus 265 may also be used to move or adjust the tank 230.

The vacuum collection truck 200 may further include a vacuum system 240 that is capable of removing sharp free glass particles from a sealed collection container 100. The vacuum system 240 may be capable of moving the sharp free glass particles to the vacuum collection truck 200. Similarly, the vacuum collection truck 200 may use an evacuation or vacuum process to remove sharp free glass from the sealed collection container 100. For example, the vacuum system may move sharp free particles from the sealed collection container 100 to the tank 230. The vacuum system 240 may include a suction hose 245. The suction hose 245 may be, for example, an abrasion resistant suction hose 245. The suction hose 245 may include an inner lining. The inner lining may be composed of any material capable of tolerating any temperature. For example, the inner lining may comprise high temperature urethane. The suction hose 245 may also comprise a PVC helix. The PVC helix may, for example, be a rigid, high-density PVC helix. The suction hose 245 and/or any other part of the vacuum system 240 may be wrapped around a short wheel and located on the vacuum collection truck 200. Accordingly, the suction hose 245 (for example, a large tube or vacuum) may be stored in a relatively small space. The suction hose 245 and/or the vacuum system 240 may be configured to engage the vacuum collection truck 200 and a sealed collection container 100. In this way, the vacuum collection truck 200 may be configured to empty sharp free particles from the sealed collection container 100 using a suction hose 245.

The vacuum collection truck 200 may empty the sealed collection container 100 quickly. For example, emptying may be performed in less than 10 minutes. The suction hose 245 may be used to remove the contents of the sealed collection container 100. The suction hose 245 may be, for example, on the order of 280 feet, although there is no minimum or maximum supported length of the suction hose 245. Thus, the vacuum collection truck 200 may be located up to, for example, 280 feet away from the sealed collection container 100. This may allow the sealed collection container 100 to be located in difficult to access locations, such as a basement or remote storage location. This may also allow the sealed collection container 100 to be located within a city in locations that would otherwise be difficult to access in order to remove or empty the sealed collection container 100. The suction power and length of the suction hose 245 therefore allow removal of glass particles that is otherwise not possible. Therefore, the power of the suction hose 245 and/or the creation of sharp free particles allow the vacuum collection truck 200 to remove glass from any area.

The suction hose 245 or any other portion of the vacuum collection truck 200 may be configured to engage the sealed collection container 100. Referring back to FIG. 1, the sealed collection container 100 may include a tank door 140 and/or a connection mechanism 180. For example, the suction hose 245 or any portion of the vacuum collection truck 200 may engage the tank door 140 or the connection mechanism 180. Therefore, the vacuum collection truck 200 may remove glass particles from the sealed collection container 100 via any engagement between the vacuum collection truck 200 and the sealed collection container 100. In one example, the suction hose 245 may engage the connection mechanism 180 and may use suction or vacuum power to remove glass particles from the sealed collection container 100. The removal of glass particles may occur regardless of the distance between the sealed collection container 100 and the vacuum collection truck 200 due to the length and or power of the suction hose 245.

As shown in FIG. 2, the vacuum collection truck 200 may include a vacuum pump 235. The vacuum pump 235 may be used for a variety of purposes, including providing vacuum power to the vacuum system 240 and/or the suction hose 245. The vacuum pump 235 may also power other features of the vacuum collection truck 200. The vacuum pump 235 may be a liquid ring vacuum pump 235 that is driven by, for example, a fenner flex coupling. The liquid ring vacuum pump 235 may be, for example, a 2,000 cubic feet per minute (cfm) liquid ring vacuum pump 235. However, any liquid vacuum pump 235 of any power may suffice to power the vacuum collection truck 200. For example, the type and power of the vacuum pump 235 may depend upon the size of the vacuum collection truck 200 and/or the tank 230. The fenner flex coupling may be powered by, for example, the engine of the vacuum collection truck 200. Any engine in the vacuum collection truck 200 may be equipped with an alternator and/or electric start equipment. The engine may be used to power the vacuum collection truck 200 or any feature of the vacuum collection truck 200.

Power to run the vacuum pump 235 or vacuum system 240 may be provided through a Power Take Off (PTO) mounted to the transmission of the vacuum collection truck 200. The vacuum pump 235 may be a liquid ring type with high CFM, high vacuum, and/or Vapor Reduction Technology (VRT). As an example, no internal oil may be required and cooling may be accomplished through the service liquid used and direct inlet cooling chambers. The vacuum pump 235 may be driven by a direct coupled hydraulic motor that may receive power from a transmission mounted direct coupled hydraulic pump.

As shown in FIG. 2, the vacuum collection truck 200 may include a rear door 250. The rear door 250 may be, for example, a top hinged door. The rear door 250 may include two hydraulic rams (in any position or on either side). The hydraulic rams may allow the rear door 250 to open across the tank 230. The hydraulic rams may secure facility for the rear door 250 to open, for example, in a raised position. The rear door 250 may include a locking system 255. The locking system 255 may include, for example, at least one set of clamping shoes, T-head bolts, and/or rods. The locking system 255 may ensure that the rear door 250 remains shut and/or may facilitate opening or closing the rear door 250.

The vacuum collection truck 200 may include optimal route software. The optimal route software may allow a driver of the vacuum collection truck 200 to reduce inefficiencies and maximize route collection. Thus, less time may be spent for collection, allowing a time savings or an increased profit margin. The optimal route software, in addition to or in combination with the GPS technology used in the sealed collection container 100 to indicate fill level, may be used to further increase the efficiency of glass collection.

The increased capacity along with the optimal route software may allow for a reduced number of vacuum collection truck 200 movements. Thus, in some instances, collections may occur as infrequently as once a month. The decrease in truck movement and required trucks may also reduce the carbon footprint of the glass collection process. Further, the glass that is collected may be re-directed from a landfill and processed for other uses, providing a further environmental benefit. The GPS, optimal route software, or any other mechanism included in the vacuum collection truck 200 or sealed collection container 100 may be used to communicate between the vacuum collection truck 200 and sealed collection container 100. For example, any information regarding the sealed collection container 100 can be accessed via the vacuum collection truck 200.

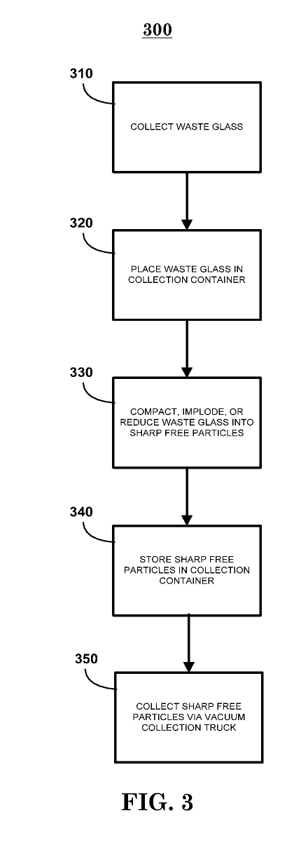

FIG. 3 shows an example process 300 for collection, implosion, and removal of glass. Waste glass may be collected 310 from an ordinary trash receptacle. The waste glass may be placed 320 in a sealed collection container 100 for processing and storage. The waste glass may be compacted, imploded, or otherwise reduced 330 into sharp free glass particles. The sharp free glass particles may comprise a significantly smaller volume than the pre-compacted waste glass. The reduction in volume may be, for example, on the order of a six-to-one reduction. The sharp free glass particles may be stored 340 in a portion of the sealed collection container 100. The sharp free glass particles may be collected 350 from the sealed collection container 100 via a vacuum collection truck 200. This may be accomplished, for example, via any of the methods or apparatus described in detail above. For example, the vacuum system 240, the suction hose 245, or any other feature of the vacuum collection truck 200 may be used to remove or collect the sharp free glass particles from the sealed collection container 100.

Although features and elements are described above in particular combinations, one of ordinary skill in the art will appreciate that each feature or element can be used alone or in any combination with the other features and elements.

What is claimed is:

1. A glass collection, implosion, and removal system comprising:
a sealed collection container configured to:
collect glass;
implode the glass into sharp free particles; and
store the imploded sharp free glass particles; and
a vacuum truck collection system configured to empty the sealed collection container, the vacuum truck collection system including a suction hose that engages the sealed collection container for emptying the sealed collection container via vacuum collection of the imploded sharp free glass particles.

2. The glass collection, implosion, and removal system of claim 1, wherein the sealed collection container is capable of containing between 1.5 and 3.5 tons of imploded glass.

3. The glass collection, implosion, and removal system of claim 1, wherein the sealed collection container includes one or more side sections.

4. The glass collection, implosion, and removal system of claim 1, wherein the sealed collection container includes global positioning system (GPS) technology.

5. The glass collection, implosion, and removal system of claim 1, wherein the sealed collection container includes noise reduction technology.

6. The glass collection, implosion, and removal system of claim 1, wherein the sealed collection container includes one or more safety features.

7. The glass collection, implosion, and removal system of claim 1, wherein the sealed collection container includes an indicator of a fill level of the sealed collection container.

8. The glass collection, implosion, and removal system of claim 1, wherein the sealed collection container includes a feed hopper.

9. The glass collection, implosion, and removal system of claim 1, wherein the vacuum truck collection system further includes a glass storage structure.

10. The glass collection, implosion, and removal system of claim 1, wherein the vacuum truck collection system uses an evacuation process to remove the sharp free glass particles from the sealed collection container.

11. The glass collection, implosion, and removal system of claim 1, wherein the vacuum truck collection system further includes a hydraulic apparatus.

12. The glass collection, implosion, and removal system of claim 1, wherein the vacuum truck collection system further includes optimal route software.

13. The glass collection, implosion, and removal system of claim 12, wherein the optimal route software is responsive to global positioning system (GPS) technology in the sealed collection container.

14. A vacuum collection truck for emptying a sealed collection container, the vacuum truck collection system comprising:
a suction hose configured to engage the sealed collection container to remove imploded sharp free glass particles from the sealed collection container via vacuum collection; and
a storage structure configured to store the imploded sharp free glass particles.

15. The vacuum collection truck of claim 14, wherein the suction hose is configured to use an evacuation process to remove the sharp free glass particles from the sealed collection container.

16. The vacuum collection truck of claim 14, further including a hydraulic apparatus.

17. The vacuum collection truck of claim 14, further including optimal route software.

18. The vacuum collection truck of claim 17, wherein the optimal route software is responsive to global positioning system (GPS) technology used in the sealed collection container.

19. A method for glass collection, implosion, and removal, the method comprising:
collecting glass in a sealed collection container;
imploding the glass into sharp free particles;
storing the imploded sharp free glass particles; and
removing the imploded sharp free glass particles from the sealed collection container via a vacuum collection truck.

20. The method of claim 19, wherein a suction hose engages the sealed collection container for emptying the sealed collection container via vacuum collection of the imploded sharp free glass particles.
